(19) United States
(12) Patent Application Publication
(10) Pub. No.: US 2004/0071904 A1
(43) Pub. Date: Apr. 15, 2004

(54) Thermoformable sheet and fuel tank incorporating same

(76) Inventor: William Thomas Short, Southfield, MI (US)

Correspondence Address: VINCENT A. CICHOSZ, DELPHI TECHNOLOGIES, INC., Legal Staff, Mail Code: 480-414-420, P.O. Box 5052, Troy, MI, 48007-5052, US

(21) Appl. No.: 10/267,973

(22) Filed: Oct. 9, 2002

(51) Int. Cl. B32B 1/02

(52) U.S. Cl. 428/35.7

(57) ABSTRACT

A thermoformable sheet includes a plurality of layers. The layers include at least an inner layer, an outer layer, and at least one barrier surface treatment disposed between the inner layer and the outer layer for forming a container such as a fuel tank.

### TECHNICAL FIELD

The present invention relates generally to thermoformable sheets with permeation barrier properties and, more particularly, to a thermoformable sheet with permeation barrier properties formed into a container such as a fuel tank for a vehicle.

### BACKGROUND OF THE INVENTION

It is known to provide a fuel tank such as a plastic fuel tank in a vehicle to hold fuel to be used by an engine of the vehicle. When a plastic fuel tank is made, the walls are formed by the co-extrusion of a multi-layer parison and blow molding it to form the tank, or by co-extruding a sheet that is vacuum formed into two shells, and welded together to form the tank. In most cases, one of the co-extruded layers is a material that is an especially effective barrier to prevent excessive permeation of fuel into the atmosphere. As effective as these tanks may be, manufacturers are constantly striving to reduce the small amounts of permeants that do escape through the tank walls, and to find more effective and cost efficient systems to do so.

One commercial approach to resolve this concern regarding permeation is to increase the thickness or number of barrier layers or increase the thickness of the walls of the fuel tank. However, there is concern that the thicker wall thickness or added materials increase cost, add weight, and increase process complexity.

Reactive surface treatments have been used for some time to decrease the permeability of barrier films and polymers generally, and in particular, for plastic fuel tanks. The processes of fluoridation, nitration, sulfonation, and amorphous carbon treatment, among others, are quick, effective, and relatively cheap. However, the treatment may be very thin, often only a few microns, and constant sloshing of fuel in a surface treated fuel tank tends to rapidly degrade the effectiveness of these treatments in actual practice. As a result, most commercial fuel tanks are being made much more complex with multi-layer sandwich structures to achieve the required diffusion properties. For example, in a typical thermoforming process, used to transform flat sheet stock into plastic fuel tanks by applying vacuum and pressure, a multi-extruder co-extrusion process is required to make the sheet for thermoforming. Another process of making the multi-layer thermoformable sheet is called piece lamination. The piece lamination process involves bringing the separate layers of the sheet together and consolidating them, either prior to forming or at the thermoformer, during the thermoforming process itself. This opens up the structure of the thermoformable sheet to potential modifications, which are not available to conventional blow molding or thermoforming operations using co-extruded sheet.

Current technologies using blown or thermoformed plastic sheets can only treat the exposed surfaces. While surface treatments have been shown to greatly improve barrier properties, the exposed treated surfaces are subject to deterioration and loss of barrier properties with time, especially in fuel tanks. In addition, the surface treatments are not durable since the fuel rapidly erodes the thin treated layer and destroys its effectiveness as an interior barrier, and chipping or abrasion destroys its effectiveness as an exterior barrier. Furthermore, only the exposed surface is available for treatment, limiting the number of treatments that can be applied to the exterior and interior of the fuel tanks.

Therefore, it is desirable to provide a sheet material for a fuel tank for a vehicle that has a more effective fuel permeation barrier to prevent evaporative emission. It is also desirable to provide a material for a fuel tank for a vehicle that decreases fuel permeation without drastically increasing weight or complexity of the fuel tank. It is further desirable to provide a plastic fuel tank for a vehicle with surface treatments that significantly reduce evaporative emission and cost of the fuel tank, and to protect those treatments from wear, erosion, or abrasion by embedding them at interior interfaces within the structure of the tank walls themselves.

### SUMMARY OF THE INVENTION

It is, therefore, one object of the present invention to provide a thermoformable permeation barrier sheet.

It is another object of the present invention to provide a container formed from a thermoformable permeation barrier sheet having permeation barrier properties.

It is yet another object of the present invention to provide a plastic fuel tank with surface treatments that significantly reduces evaporative emission and cost.

To achieve the foregoing objects, the present invention is thermoformable sheet including a plurality of layers. The layers include at least an inner layer, an outer layer, and at least one barrier surface treatment disposed between the inner layer and the outer layer.

In addition, the present invention is a container including at least one wall formed from a plurality of layers. The layers include at least an inner layer, an outer layer, and at least one barrier surface treatment disposed between the inner layer and outer layer.

Further, the present invention is a fuel permeation barrier fuel tank for a vehicle including a tank shell having a wall formed from a plurality of layers. The layers include at least an inner layer, an outer layer, and at least one barrier surface treatment disposed between the inner layer and outer layer.

One advantage of the present invention is that a fuel permeation barrier fuel tank is provided for a vehicle that has a more effective fuel permeation barrier leading to less evaporative emission. Another advantage of the present invention is that the fuel permeation barrier fuel tank combines surface treatments on layers separately, instead of co-extruding them, and imbeds the surface treatments deep within the walls of the fuel tank where the permeation surface treatment is protected from erosion or degradation. Yet another advantage of the present invention is that the fuel permeation barrier fuel tank has enhanced performance, especially for fuel systems exposed to multiple fuel (or permeant) blends, since the surface treatment can either augment the barrier layer or supply additional barrier properties for permeants for which the barrier layer is less effective, especially for hydrocarbon fuel blends with methanol and ethanol. Still another advantage of the present invention is that the fuel permeation barrier fuel tank reduces or eliminates use of expensive barrier layer materials required for a given level of performance, thereby lowering cost of the fuel tank. A further advantage of the present invention is that the fuel permeation barrier fuel tank has reduced weight and enhanced performance through multiple surface treatments. Yet a further advantage of the present invention is that the fuel permeation barrier fuel tank has a surface treatment within the walls of the fuel tank, thereby avoiding micro-cracking when the fuel tank is formed.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a diagrammatic view of a thermoformable sheet, according to the present invention, for forming a container such as a fuel permeation barrier fuel tank of FIGS. 2 and 3.

FIG. 2 is a perspective view of a fuel permeation barrier fuel tank, according to the present invention, formed from the thermoformable sheet of FIG. 1.

FIG. 3 is a fragmentary view of the fuel permeation barrier fuel tank of FIG. 2.

### DESCRIPTION OF THE PREFERRED EMBODIMENT

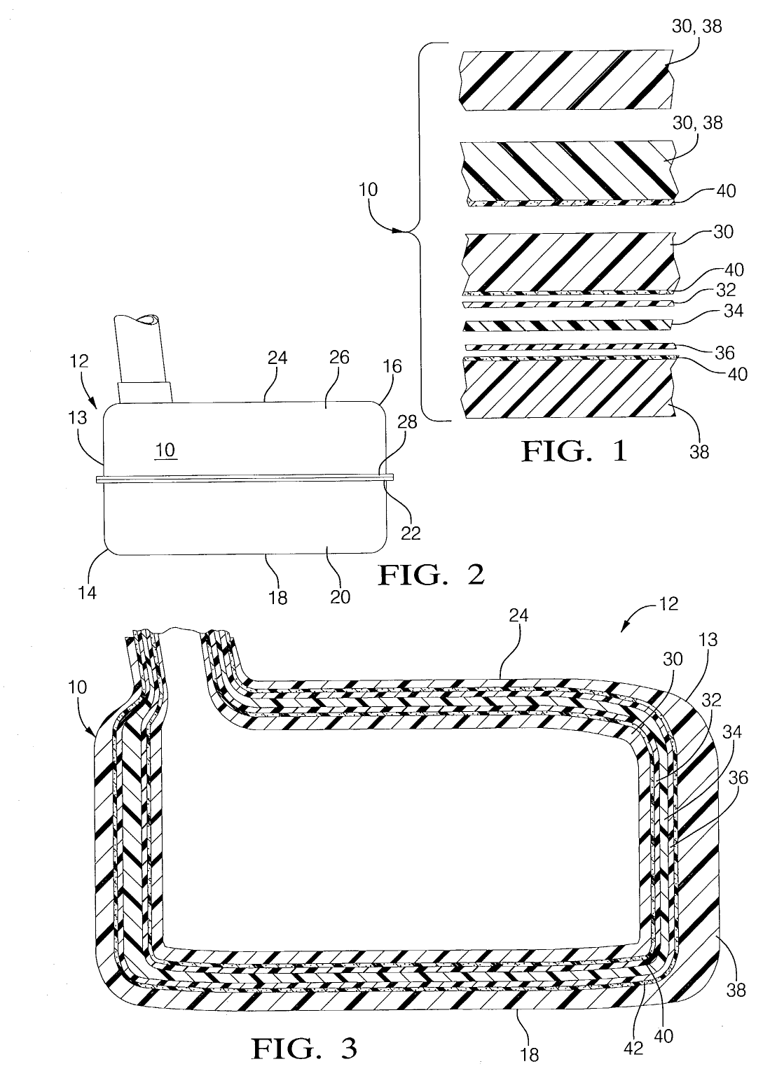

Referring to the drawings and in particular FIG. 1, a thermoformable sheet 10, according to the present invention, for forming a container such as a fuel permeation barrier fuel tank 12 of FIGS. 2 and 3 is shown. The thermoformable sheet 10 includes a plurality of separate layers 30,32,34,36,38. The first layer 30 is an inner layer made from a high-density polyethylene (HDPE), which is a conventional material known in the art. The first layer 30 has a predetermined thickness of approximately one millimeter (1.00 mm) to four millimeters (4.00 mm).

The second layer 32 is an adhesive layer made from an adhesive such as maleated polyethylene (ADMER Grade GT6A), which is a conventional material known in the art. The second layer 32 has a predetermined thickness of approximately 0.07 mm. It should be appreciated that the adhesives bind the HDPE to a barrier layer to be described. As illustrated in FIG. 1, the adhesive layers 32 are shown as separate layers. It should also be appreciated that these adhesives can be soluble and can be applied with a spray gun or coater (not shown) to either the wall or barrier layers, or extruded separately from the other layers or coextruded with the barrier layer and laminated to the wall layers where appropriate. It should be appreciated that other adhesion materials may be substituted depending upon the wall barrier polymer selected.

The third layer 34 is a barrier layer made from an ethylene vinyl alcohol (EVOH) copolymer, which is a conventional material known in the art. The third layer 34 has a predetermined thickness of approximately 0.4 mm. It should be appreciated that the barrier layer may also be made from polyethylene terephthalate, tetrafluoroethylene-hexafluoropropylene-vinylidene fluoride terpolymer (TVH), liquid crystalline polymers such as Vectra, which is commercially available from Hoechst Celanese, polyamides, or other barrier polymers.

The fourth layer 36 is an adhesive layer made from an adhesive such as maleated polyethylene (ADMER Grade GT6A), which is a conventional material known in the art. The fourth layer 36 has a predetermined thickness of approximately 0.07 mm. It should be appreciated that the fourth layer 36 is similar to the second layer 32.

The fifth layer 38 is an outer layer made from a high-density polyethylene (HDPE), which is a conventional material known in the art. The fifth layer 38 has a predetermined thickness of approximately one millimeter (1.00 mm) to approximately four millimeters (4.00 mm). It should be appreciated that the layers 30,32,34,36,38 have a total thickness of approximately two millimeters (2.00 mm) to approximately ten millimeters (10.00 mm). It should also be appreciated that the fifth layer 38 may also contain regrind scrap material or the thermoformable sheet 10 may include a separate sixth layer (not shown) of regrind scrap material.

The thermoformable sheet 10 includes at least one an internal barrier surface treatment 40. The barrier surface treatment 40 is a reactive surface treatment and may be of a sulfonated, nitrated, fluorinated, and/or plasma deposited amorphous carbon material. The barrier surface treatment 40 is internal to the outer surface and inner surface of the base walls 18,24, side walls 20,26, and flanges 22,28. The barrier surface treatment 40 is disposed on the interior surface of at least one of the layers 30,32,34,36,38. In one embodiment as illustrated in FIG. 1, the barrier surface treatment 40 is on both the interior surface of the inner layer 32 and outer layer 38.

The thermoformable sheet 10 is formed by applying the surface treatment 40 from a liquid or gaseous solution, by direct contact from a gas or liquid, as gaseous plasma or by other means, to either one or both of the layers 30,38. The method also includes bringing the separated layers 30,32,34,36,38 of the sheet together either prior to forming or at a thermoformer (not shown), and consolidating the sheet during the thermoforming process as illustrated in FIG. 1. It should be appreciated that both the barrier layer 34 and at least one of the adhesive layers 32,36 could be removed with the barrier properties being provided solely by the surface treatment 40 in the interior between the inner and outer layers 30 and 38. It should also be appreciated that there is no restriction on treating different layers of the laminate with different surface treatments 40 to expand the range of permeants to which the thermoformed fuel tank 12 is protected. It should further be appreciated that the layer 30,38 having the surface treatment 40 should reduce permeability to the desired gas or fluid, that it retain sufficient barrier properties on thermoforming, that at least one of the treated surfaces be incorporated in an interior position in the thermoformable sheet laminate, and that the treated layer bond sufficiently with the adjacent layer 32,34,36 to provide a structural unit after it is formed into the fuel tank 12. It should still further be appreciated that the one or more of the surfaces of the layers 30,32,34,36,38 is treated by the surface treatment 40 to reduce its permeability, and the treated layer is then incorporated as an internal surface to the thermoformable sheet for the fuel tank 12.

Referring to FIGS. 2 and 3, one embodiment of a fuel permeation barrier fuel tank 12, according to the present invention, is shown for a vehicle (not shown). The fuel permeation barrier fuel tank 12 includes a tank shell 13. The tank shell 13 includes a first or lower half shell 14 and a second or upper half shell 16. The lower half shell 14 has a base wall 18 and a side wall 20 around a periphery of the base wall 18 and extending generally perpendicular thereto. The side wall 20 has a flange 22 extending outwardly and generally perpendicular thereto. The upper half shell 16 has a base wall 24 and a side wall 26 around a periphery of the base wall 24 and extending generally perpendicular thereto. The side wall 26 has a flange 28 extending outwardly and generally perpendicular thereto. The flanges 22 and 28 of the lower half shell 14 and upper half shell 16, respectively, are joined together to form a seam by suitable means such as by thermoforming, compression molding, or friction welding. The base walls 18,24, side walls 20,26, and flanges 22,28 are formed from the thermoformable sheet 10 of the layers 30,32,34,36,38. It should be appreciated that the barrier surface treatment 40 is disposed on the layers 30,32,34,36,38, separately, instead of co-extruding them, and imbeds the barrier surface treatment 40 deep within the base walls 18,24, side walls 20,26, and flanges 22,28 of the fuel tank 12 where the surface treatment 40 is protected from erosion or degradation by the fuel therein.

Accordingly, the surface treatment 40 allows the amount of polymer in the barrier layer 34 to be reduced. By combining the layers 30,32,34,36,38, separately, instead of co-extruding them, the surface treatment 40 is imbedded deep within the walls of the fuel tank 12 where the surface treatment 40 is protected from erosion or degradation. The fuel tank 12 has the potential reduction in overall tank weight, since wall thickness is reduced for any given level of permeation. It should be appreciated that treatment of any of the layers 30,32,34,36,38 of the fuel tank 12 is possible with the surface treatment 40.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A thermoformable sheet comprising:
a plurality of layers;
said layers comprising at least an inner layer, an outer layer, and at least one barrier surface treatment disposed between said inner layer and said outer layer.

2. A thermoformable sheet as set forth in claim 1 wherein said at least one barrier surface treatment is one of group comprising sulfonated, nitrated, fluorinated and plasma deposited amorphous carbon material.

3. A thermoformable sheet as set forth in claim 1 wherein said inner layer and said outer layer are made of a polyethylene material.

4. A thermoformable sheet set forth in claim 1 wherein said layers include a permeation barrier layer.

5. A thermoformable sheet as set forth in claim 4 including a first adhesive layer disposed between said permeation barrier layer and said inner layer.

6. A thermoformable sheet as set forth in claim 5 including a second adhesive layer disposed between said permeation barrier layer and said outer layer.

7. A thermoformable sheet as set forth in claim 5 wherein said at least one barrier surface treatment is disposed between said first adhesive layer and said inner layer.

8. A thermoformable sheet as set forth in claim 5 wherein said at least one barrier surface treatment is disposed between said second adhesive layer and said outer layer.

9. A thermoformable sheet as set forth in claim 1 wherein said at least one barrier surface treatment is disposed on an interior surface of said inner layer.

10. A thermoformable sheet as set forth in claim 1 wherein said at least one barrier surface treatment is disposed on an interior surface of said outer layer.

11. A thermoformable sheet as set forth in claim 1 wherein said at least one barrier surface treatment is a reactive surface treatment.

12. A container comprising:
at least one wall formed from a plurality of layers;
said layers comprising at least an inner layer, an outer layer, and at least one barrier surface treatment disposed between said inner layer and said outer layer.

13. A container as set forth in claim 12 wherein said at least one barrier surface treatment is one of group comprising sulfonated, nitrated, fluorinated and carbon plasma material.

14. A container as set forth in claim 12 wherein said inner layer and said outer layer are made of a polyethylene material.

15. A container as set forth in claim 12 including a permeation barrier layer disposed between said inner layer and said outer layer.

16. A container as set forth in claim 15 including a first adhesive layer disposed between said fuel permeation barrier layer and said inner layer.

17. A container as set forth in claim 16 including a second adhesive layer disposed between said fuel permeation barrier layer and said outer layer.

18. A container as set forth in claim 17 wherein said at least one barrier surface treatment is disposed between said first adhesive layer and said inner layer.

19. A container as set forth in claim 17 wherein said at least one barrier surface treatment is disposed between said second adhesive layer and said outer layer.

20. A container as set forth in claim 12 wherein said at least one barrier surface treatment is disposed on an interior surface of said inner layer.

21. A container as set forth in claim 12 wherein said at least one barrier surface treatment is disposed on an interior surface of said outer layer.

22. A container as set forth in claim 12 wherein said at least one barrier surface treatment is a reactive surface treatment.

23. A fuel permeation barrier fuel tank for a vehicle comprising:
a tank shell having a wall formed from a plurality of layers;
said layers comprising at least an inner layer, an outer layer, and at least one barrier surface treatment disposed between said inner layer and said outer layer.

24. A fuel permeation barrier fuel tank as set forth in claim 23 wherein said at least one barrier surface treatment is one of group comprising sulfonated, nitrated, fluorinated and carbon plasma material.

25. A fuel permeation barrier fuel tank as set forth in claim 23 wherein said inner layer and said outer layer are made of a polyethylene material.

26. A fuel permeation barrier fuel tank as set forth in claim 23 including a fuel permeation barrier layer disposed between said inner layer and said outer layer.

27. A fuel permeation barrier fuel tank as set forth in claim 26 including a first adhesive layer disposed between said fuel permeation barrier layer and said inner layer.

28. A fuel permeation barrier fuel tank as set forth in claim 27 including a second adhesive layer disposed between said fuel permeation barrier layer and said outer layer.

29. A fuel permeation barrier fuel tank as set forth in claim 27 wherein said at least one barrier surface treatment is disposed between said first adhesive layer and said inner layer.

30. A fuel permeation barrier fuel tank as set forth in claim 27 wherein said at least one barrier surface treatment is disposed between said second adhesive layer and said outer layer.

31. A fuel permeation barrier fuel tank as set forth in claim 23 wherein said at least one barrier surface treatment is disposed on an interior surface of said inner layer.

32. A fuel permeation barrier fuel tank as set forth in claim 23 wherein said at least one barrier surface treatment is disposed on an interior surface of said outer layer.

33. A fuel permeation barrier fuel tank as set forth in claim 23 wherein said at least one barrier surface treatment is a reactive surface treatment.

34. A fuel permeation barrier fuel tank for a vehicle comprising:
a tank shell having a wall formed from a plurality of layers;
said layers comprising at least an inner layer, an outer layer, a fuel permeation barrier layer disposed between said inner layer and said outer layer, at least one adhesive layer disposed between either said inner layer and said outer layer and said fuel permeation barrier layer, and at least one barrier surface treatment disposed between said inner layer and said outer layer.
